(19) United States
(12) Patent Application Publication
(10) Pub. No.: US 2003/0182189 A1
(43) Pub. Date: Sep. 25, 2003

(54) Advertisement server, advertisement attaching method, and advertisement information attaching program

(75) Inventors: Hiroshi Yoshida, Kawasaki (JP); Nagumo Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/293,682

(22) Filed: Nov. 14, 2002

(30) Foreign Application Priority Data
Mar. 22, 2002 (JP) 2002-081387

(51) Int. Cl. G06F 17/60

(52) U.S. Cl. 705/14

(57) ABSTRACT

A list of the advertisement information relating to advertisement information attached to the electronic mail transmitted by the transmitter terminal is generated based on an advertisement information database storing advertisement information and advertisement registration information containing an advertisement information identifier to designate the advertisement information and a relevant advertisement information identifier to designate an advertisement information class relating to the advertisement information, and a user information database storing user information containing a transmitter terminal identifier to designate the transmitter terminal and an advertisement information identifier to designate the advertisement information attached to the electronic mail transmitted from the transmitter terminal, and the advertisement information selected by the transmitter terminal from the list is attached to the electronic mail transmitting to the receiver terminal, thereby providing an advertisement server capable of attaching an advertisement having interesting contents for the transmitter and the receiver of electronic mail.

### BACKGROUND OF THE INVENTION

1. Field of the Invention

The present invention relates to an electronic mail advertisement system in which a public network is used as a communications infrastructure for application to an electronic mail server system, and more specifically to an advertisement server, an advertisement attaching method, and an advertisement information attaching program for attaching advertisement information meeting the taste of the transmitter and the receiver to the electronic mail transmitted from the transmitter terminal to the receiver terminal.

2. Description of the Related Art

Recently, an advertising banner on a WWW page and an electronic mail advertisement in an electronic mail magazine appear in the fields of Internet, and attract much attention as new advertisement media through Internet.

The electronic mail (E-mail) through a mobile telephone, a PHS, Internet, etc. has become widespread as communications means for connection established between two stations through a public network, that is, point-to-point connection.

Normally, to use the above mentioned communications means, a use rate including a communications rate is charged each time any means is used in addition to the fixed rate such as a monthly rate, etc. As a method of a user of electronic mail using the mail free of charge, there is a service of a provider who manages an electronic mail server forcibly issuing mail.

However, in the conventional services, a provider selects an advertisement for attachment. Therefore, a transmitter of electronic mail has the problem that an insignificant advertisement is attached.

Furthermore, a receiver of electronic mail has the problem that there is a small probability that an attached advertisement belongs to an interesting field for the receiver.

Additionally, since there are the above mentioned problems, there has been an additional problem that the effect of the advertisement attached to electronic mail is not so high.

### SUMMARY OF THE INVENTION

The present invention has been developed to solve the above mentioned problems, and aims at providing an advertisement server, an advertisement attaching method, and an advertisement information attaching program capable of attaching an advertisement having interesting contents (meeting the taste) for the transmitter and the receiver of electronic mail.

The present invention also aims at providing an advertisement server, an advertisement attaching method, and an advertisement information attaching program capable of selecting an advertisement which is interesting for the transmitter and the receiver of electronic mail and has new contents.

The advertisement server according to the present invention attaches advertisement information to electronic mail transmitted from a transmitter terminal to a receiver terminal and performs relay control, and includes a advertisement information database, a user information database, a advertisement list information generation unit, and an advertisement attachment unit.

According to the first aspect of the present invention, the advertisement information database stores advertisement information, and advertisement registration information containing an advertisement information identifier to designate the advertisement information and a relevant advertisement information identifier to designate an advertisement information class about the advertisement information.

The user information database stores user information containing a transmitter terminal identifier to designate the transmitter terminal and an advertisement information identifier to designate advertisement information attached to the electronic mail transmitted from the transmitter terminal.

The advertisement list information generation unit generates a list of advertisement information relating to the advertisement information attached to the electronic mail transmitted by the transmitter terminal based on the advertisement information database and the user information database.

The advertisement attachment unit attaches the advertisement information selected by the transmitter terminal from the list generated by the advertisement list information generation unit to the electronic mail transmitting to the receiver terminal.

### BRIEF DESCRIPTION OF THE DRAWINGS

FIG. 1 shows the outline of the advertisement server according to the present invention;

FIG. 2 shows the relationship between an advertisement server and a client device;

FIG. 3 shows the data structure of an advertisement information database;

FIG. 4 shows the data structure of a user information database;

FIG. 5 is a flowchart of the automatic issuing process on information mail;

FIG. 6 is a flowchart of the advertisement list information generating process;

FIG. 7 is a flowchart of the use point process;

FIG. 8 is a flowchart of the relay control process on electronic mail;

FIG. 9 is a flowchart of the process of amending a used advertisement ID list of a user information database;

FIG. 10 is a flowchart of the process of amending an applying user ID list of an advertisement information database;

FIG. 11 is a flowchart of the process of amending an accumulated use point of an advertisement information database;

FIG. 12 is a flowchart of the process of amending an accumulated use point of a user information database;

FIG. 13 is a flowchart of the process of attaching advertisement information to electronic mail;

FIG. 14 shows an example of a relevant advertisement ID;

FIG. 15 shows an example of information mail;

FIG. 16 shows the configuration of the advertisement server according to the present invention; and

FIG. 17 shows loading the advertisement information attaching program according to the present invention into a computer.

### DESCRIPTION OF THE PREFERRED EMBODIMENT

An embodiment of the present invention is described below by referring to the attached drawings.

The present invention has the following configuration to solve the above mentioned problems.

That is, according to an embodiment of the present invention, the advertisement server of the present invention attaches advertisement information to the electronic mail transmitted from a transmitter terminal to a receiver terminal, and performs relay control therefor, and comprises: an advertisement information database storing advertisement information and advertisement registration information containing an advertisement information identifier to designate the advertisement information and a relevant advertisement information identifier to designate an advertisement information class relating to the advertisement information; a user information database storing user information containing a transmitter terminal identifier to designate the transmitter terminal and an advertisement information identifier to designate the advertisement information attached to the electronic mail transmitted from the transmitter terminal; an advertisement list information generation unit for generating a list of the advertisement information relating to the advertisement information attached to the electronic mail transmitted by the transmitter terminal based on the advertisement information database and the user information database; and an advertisement attachment unit for attaching the advertisement information selected by the transmitter terminal from the list generated by the advertisement list information generation unit to the electronic mail transmitting to the receiver terminal.

In the advertisement server according to the present invention, it is desired that the user information database stores the user information further containing a receiver terminal identifier to designate the receiver terminal, and the advertisement list information generation unit generates a list of the advertisement information relating to the advertisement information attached to the electronic mail transmitted from the transmitter terminal to the receiver terminal.

It is also desired that the advertisement server further comprises an advertisement registration information storage unit for receiving the advertisement information and registering the received advertisement information in the advertisement information database together with the advertisement information identifier to designate the received advertisement information and the relevant advertisement information identifier to designate the advertisement information class relating to the received advertisement information.

It is further desired that the advertisement server according to the present invention further comprises an information mail automatic transmission unit for generating information mail based on the advertisement information registered in the advertisement information database by the advertisement registration information storage unit and the user information database, and transmitting the mail to the transmitter terminal.

It is further desired that, in the advertisement server according to the present invention, the information mail automatic transmission unit transmits the information mail to the transmitter terminal when the advertisement registration information storage unit registers the advertisement information in the advertisement information database.

It is further desired that, in the advertisement server according to the present invention, the advertisement list information generation unit generates a list of the advertisement information based on the frequency of the transmission of the advertisement information transmitted as attachment to electronic mail.

It is also desired that the advertisement server according to the present invention further comprises a relevant advertisement information list transmission unit for transmitting the list of the advertisement information generated by the advertisement list information generation unit to the transmitter terminal.

It is further desired that the advertisement server according to the present invention further comprises: an electronic mail transmission unit for transferring the electronic mail to which the advertisement attachment unit attaches the advertisement information from the transmitter terminal to the receiver terminal; and a use point control unit for adding a use point each time the advertisement information is attached by the advertisement attachment unit, and storing the use point in the user information database.

It is also desired that, in the advertisement server according to the present invention, the above mentioned use point depends on the advertisement information.

With the above mentioned configurations of the advertisement server according to the present invention, the advertising effect for the commercial sponsor can be largely improved, and the transmitter of the electronic mail can freely select a desired advertisement from among the latest advertisements, thereby improving the satisfaction level of an information transmission. For the provider (the manager of the advertisement server) can easily update an advertisement, thereby easily managing the commissions.

With the above mentioned configuration of the advertisement server according to the present invention, the transmitter of the electronic mail can attach an advertisement to the taste of the receiver of the electronic mail, and update an advertisement DB.

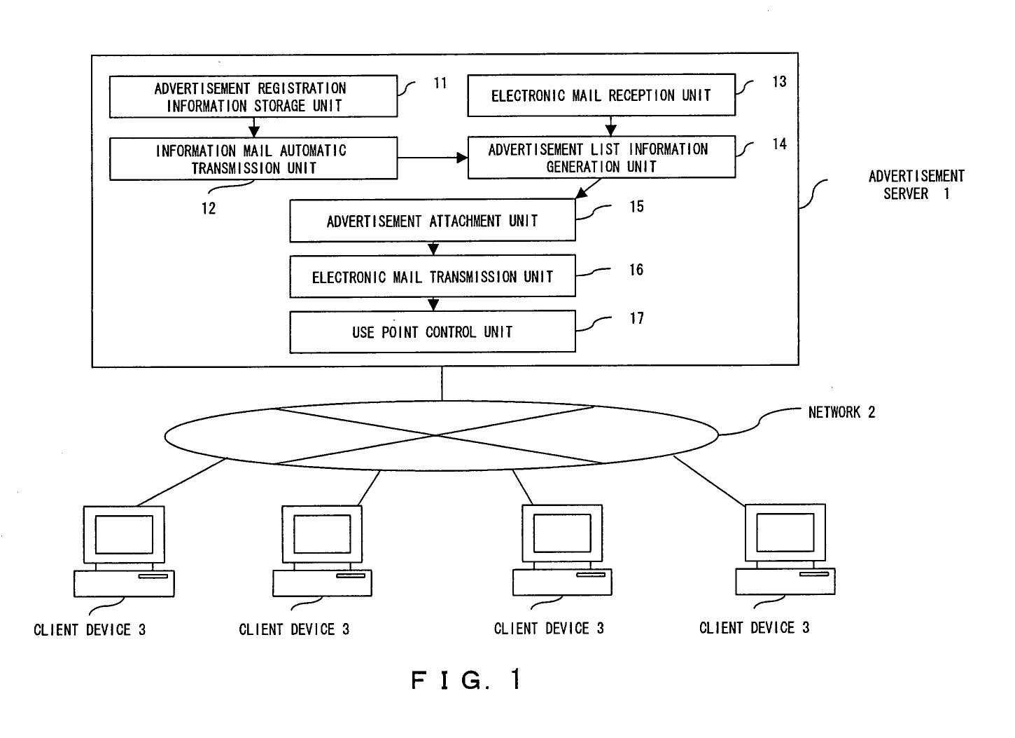

FIG. 1 shows the outline of the advertisement server according to the present invention.

In FIG. 1, an advertisement server 1 is connected to a client device 3 such as a commercial sponsor terminal, an electronic mail transmitter terminal, an electronic mail receiver terminal, etc. through a network 2 such as Internet, etc., and comprises an advertisement registration information storage unit 11, an information mail automatic transmission unit 12, an electronic mail reception unit 13, an advertisement list information generation unit 14, an advertisement attachment unit 15, an electronic mail transmission unit 16, and a use point control unit 17.

The advertisement registration information storage unit 11 receives the advertisement information from the commercial sponsor terminal (client device 3) through the network 2, and registers the received advertisement information in the database (an advertisement information database 18 described later) together with the advertisement information identifier (advertisement ID) to designate the received advertisement information and the relevant advertisement information identifier (relevant advertisement ID) to designate the group (advertisement information class) of the advertisement information relating to the received advertisement information.

The information mail automatic transmission unit 12 generates the information mail relating to the advertisement information registered in the advertisement information database 18 based on the advertisement information registered in the database (advertisement information database 18) by the advertisement registration information storage unit 11 and the database (a user information database 19 described later) storing the information about the user, and transmits the information mail to the transmitter terminal (client device 3) through the network 2.

The electronic mail reception unit 13 receives the electronic mail transmitted from the transmitter terminal (client device 3) to the receiver terminal (client device 3) to attach the advertisement information thereto.

The advertisement list information generation unit 14 generates a list of the advertisement information relating to the advertisement information attached to the electronic mail previously transmitted by a specific transmitter terminal (client device 3) based on the above mentioned two databases (the advertisement information database 18 and the user information database 19). At this time, the advertisement list information generation unit 14 is desired to generate a list of the advertisement information relating to the advertisement information attached to the electronic mail transmitted from a specific transmitter terminal (client device 3) to a specific receiver terminal (client device 3).

The advertisement attachment unit 15 attaches the advertisement information selected by the transmitter terminal (client device 3) from the list generated by the advertisement list information generation unit 14 to the electronic mail transmitting to the receiver terminal (client device 3).

It is desired that the transmitter terminal (client device 3) selects the advertisement information by transmitting in advance the list of the advertisement information generated by the advertisement list information generation unit 14 to the above mentioned transmitter terminal (client device 3).

The electronic mail transmission unit 16 transfers the electronic mail to which the advertisement attachment unit 15 has attached the advertisement information from the transmitter terminal (client device 3) to the receiver terminal (client device 3).

The use point control unit 17 adds a use point each time the advertisement attachment unit 15 attaches the advertisement information, and stores the use point in the database (user information database 19) storing the information about the user. The use points can be different depending on the advertisement information.

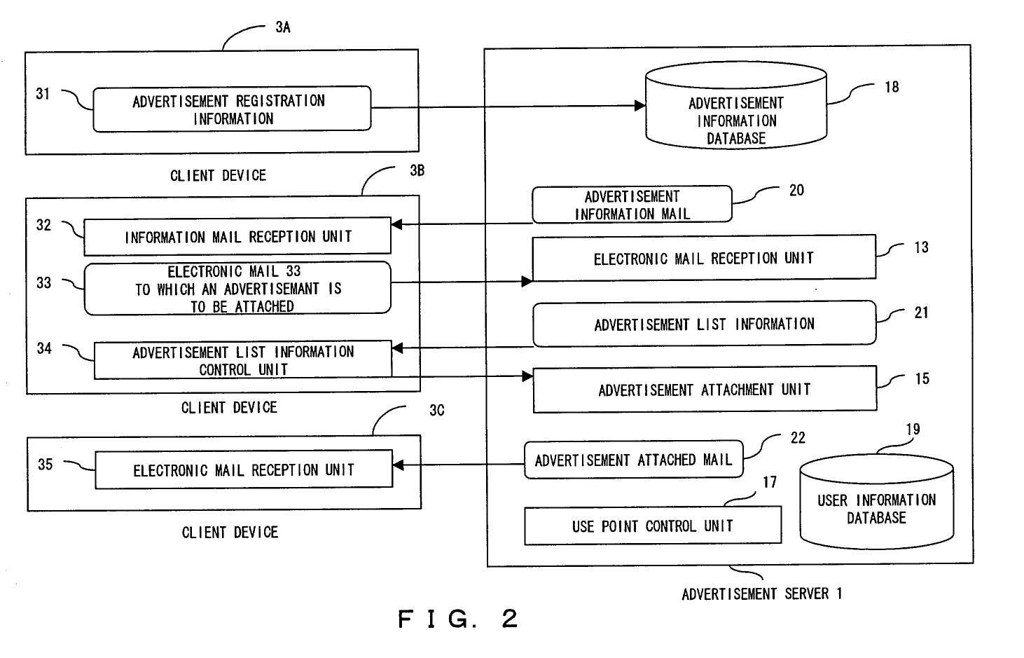

FIG. 2 shows the relationship between the advertisement server and the client device.

In FIG. 2, a client device 3A is a commercial sponsor terminal of a company or a common user, a client device 3B is a transmitter terminal provided with an information mail reception unit 32 and an advertisement list information control unit 34, and a client device 3C is a receiver terminal provided with an electronic mail reception unit 35. The advertisement server 1 further comprises the advertisement information database 18 and user information database 19 in addition to the above mentioned electronic mail reception unit 13, advertisement attachment unit 15, and use point control unit 17.

The advertisement information database 18 stores at least the advertisement information which is the contents of the advertisement, and advertisement registration information 31 containing the advertisement information identifier (advertisement ID) to designate the advertisement information and the relevant advertisement information identifier (relevant advertisement ID) to designate the group (advertisement information class) of the advertisement information relating to the advertisement information.

Additionally, the user information database 19 stores the user information containing at least the transmitter terminal identifier (user ID and a mail address) to designate the client terminal (transmitter terminal) 3B and the advertisement information identifier (advertisement ID) to designate the advertisement information attached to the electronic mail transmitted from the client terminal (transmitter terminal) 3B. The user information can also contain a receiver terminal identifier to designate the client terminal (receiver terminal) 3C.

In the relationship between the client device (commercial sponsor terminal) 3A and the advertisement server 1, the advertisement registration information 31 can be registered in the advertisement information database 18 by transmitting the advertisement registration information 31 stored by the client device 3A to the advertisement server 1.

In the relationship between the client device (transmitter terminal) 3B and the advertisement server 1, the information mail reception unit 32 receives advertisement information mail 20 generated by the advertisement server 1. The electronic mail reception unit 13 receives the electronic mail transmitted from the client device 3B to the client device 3C to attach the advertisement information stored in the advertisement information database 18 thereto. The advertisement list information control unit 34 receives advertisement list information 21 generated by the advertisement server 1, and performs control by displaying it for selection, etc.

In the relationship between the client device (receiver terminal) 3C and the advertisement server 1, the electronic mail reception unit 35 receives electronic mail (advertisement attached mail) 22 to which the advertisement server 1 has attached the advertisement information.

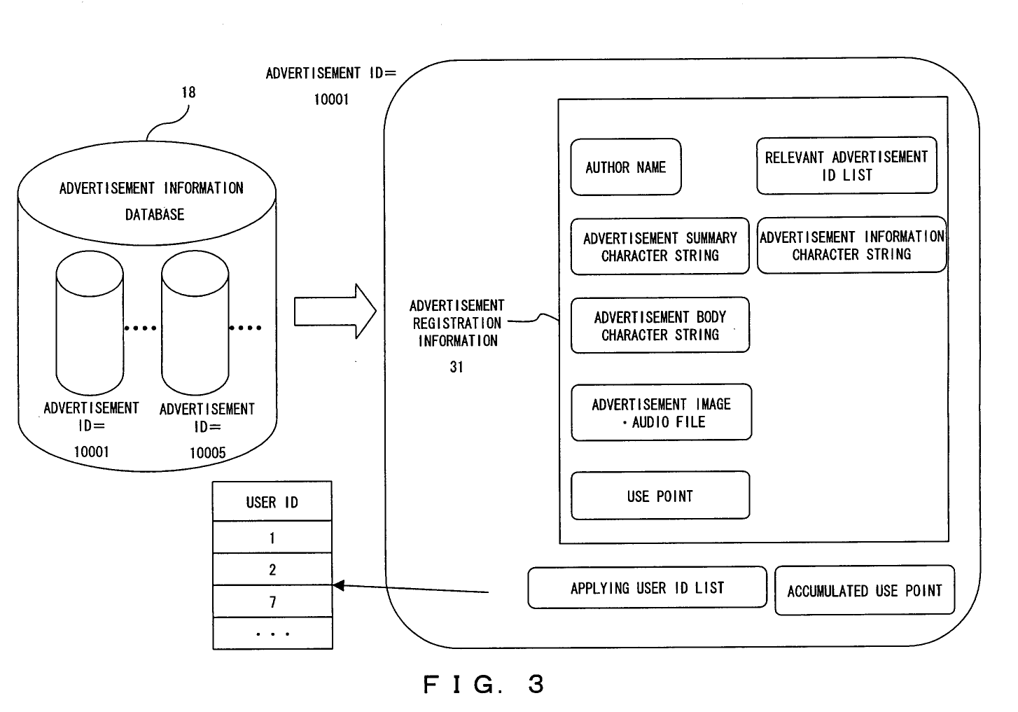

FIG. 3 shows the data structure of the advertisement information database.

In FIG. 3, the advertisement information database 18 stores the advertisement registration information 31 for each advertisement ID (for example, 10001, 10005, etc.) to designate the advertisement information. The advertisement registration information 31 contains an author name, an advertisement summary character string, an advertisement body character string, an advertisement image, an audio file, a use point, a relevant advertisement ID list, and an advertisement information character string. Additionally, the user ID list (applying user ID list) to designate a user (a user of the transmitter terminal or a user of the receiver terminal) using the advertisement registration information 31 (attached to the electronic mail) and the accumulated use point are stored as associated with the advertisement registration information 31.

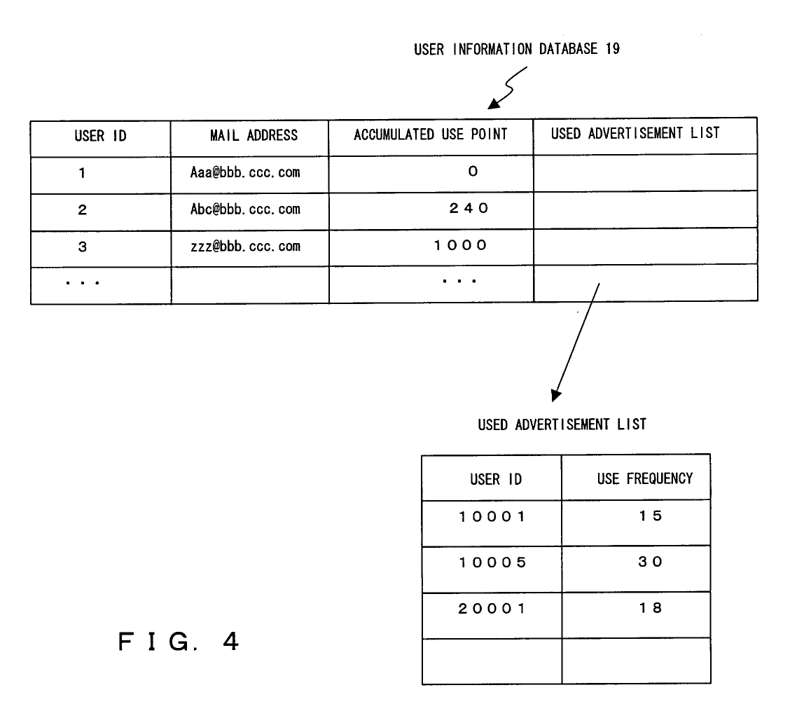

FIG. 4 shows the data structure of the user information database.

In FIG. 4, the user information database 19 is configured by the records of the users of the transmitter terminal 3B with each record containing the user ID to designate the user of the transmitter terminal 3B, the mail address of the user, the accumulated use point, and the used advertisement list which is the advertisement ID list of used advertisement information. It is desired that these records are set for the respective users of the receiver terminal 3C. The database can also be configured by the records of the users of the receiver terminal 3 with each record set for a user of the receiver terminal 3C.

The used advertisement list is configured by the list of the combinations of the advertisement IDs and the use frequencies of the advertisement information.

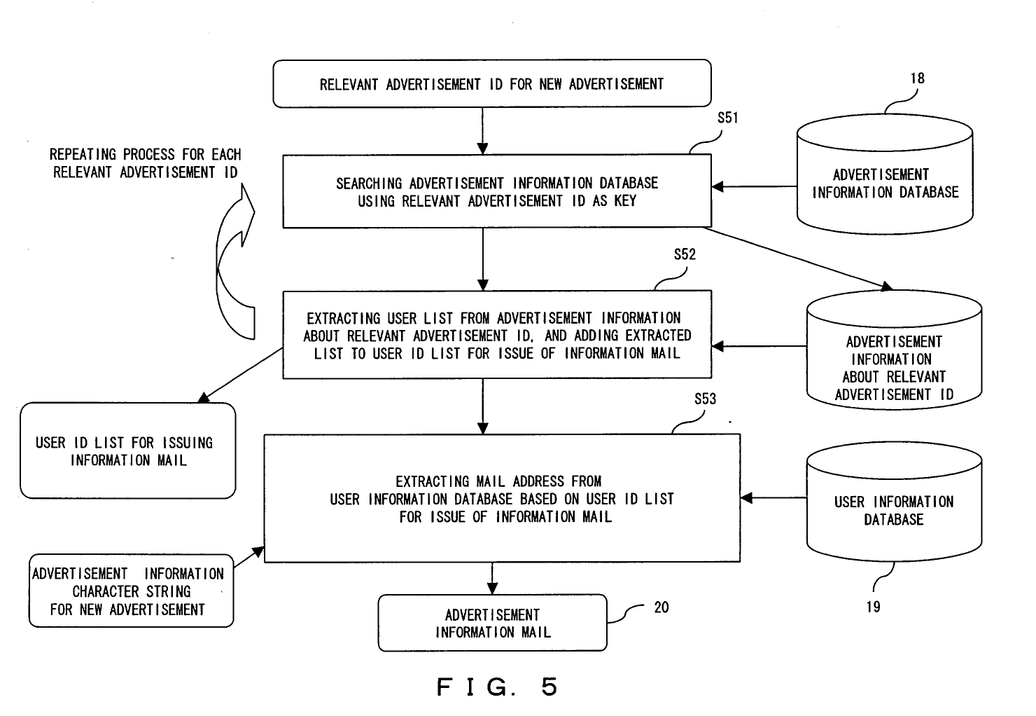

FIG. 5 is a flowchart of the automatic issuing process of the information mail.

First, when new advertisement information is transmitted from the client device 3A to the advertisement server 1 through the network 2, the advertisement registration information storage unit 11 searches the advertisement information database 18 in step S51 using the relevant advertisement ID in the relevant advertisement ID list of the advertisement registration information 31 as a key.

In step S52, a user list is extracted from the advertisement information about the relevant advertisement ID, and adds the extracted list to the user list for issue of information mail.

The processes in steps S51 and S52 are repeated the times of the number of relevant advertisement IDs in the relevant advertisement ID.

Then, in step S53, a mail address is extracted from the user information database 19 based on the user list for issue of information mail added in step S52, and the advertisement information character string is transmitted as the advertisement information mail 20 to the transmitter terminal 3B.

The advertisement information mail 20 can be transmitted when the advertisement registration information storage unit 11 registers the advertisement information in the advertisement information database 18 as described above, or at predetermined time intervals (at 8:00 every morning, every Monday, etc.), or when new advertisement information reaches a predetermined amount.

Instead of the processes in steps S51 and S52 repeated the times of the number of relevant advertisement IDs in the relevant advertisement ID, the searching operations can be simultaneously performed using a logical sum of a plurality of relevant advertisement IDs.

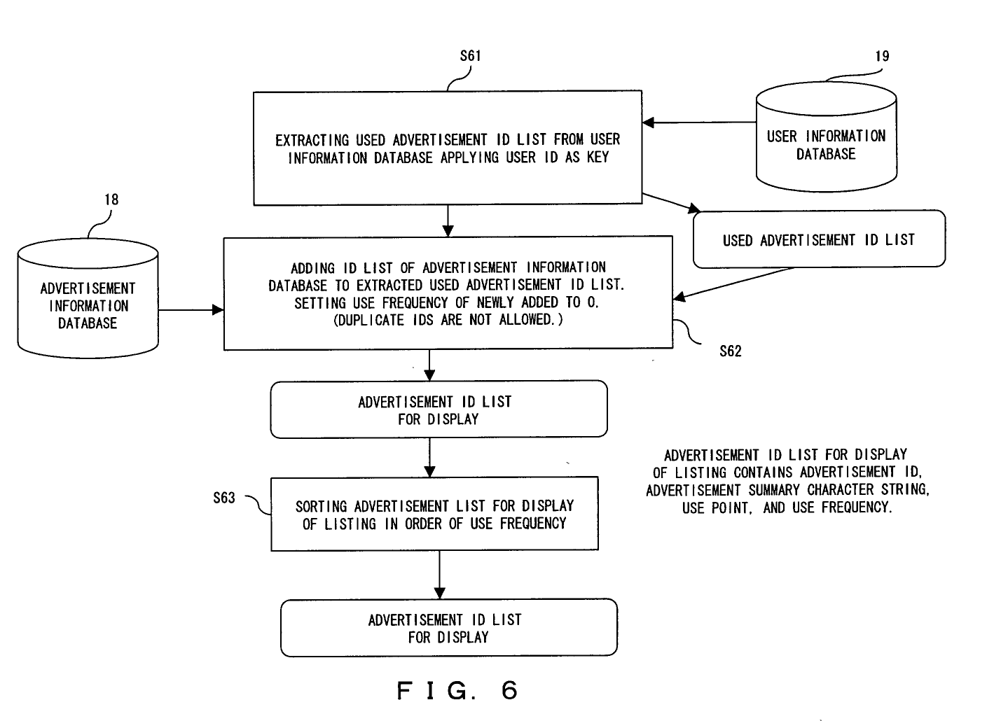

FIG. 6 is a flowchart of the advertisement list information generating process.

First, in step S61, a used advertisement ID list is extracted from the user information database 19 using the user ID of the user of the transmitter terminal 3B as a key, or using the combination of the user ID of the user of the transmitter terminal 3B and the user ID of the user of the receiver terminal 3C as a key.

In step S62, a list of the user IDs of the advertisement information database 18 is added to the extracted used advertisement ID list to prepare an advertisement ID list for display of listing containing an advertisement ID, an advertisement summary character string, a use point, and a use frequency. The use frequency for the newly added information is set to 0.

In step S63, the advertisement list for display of listing is sorted in the order of use frequency. That is, the advertisement list for display of listing (list of the advertisement information) is generated based on the frequency of transmitting the advertisement information transmitted as attached to the electronic mail.

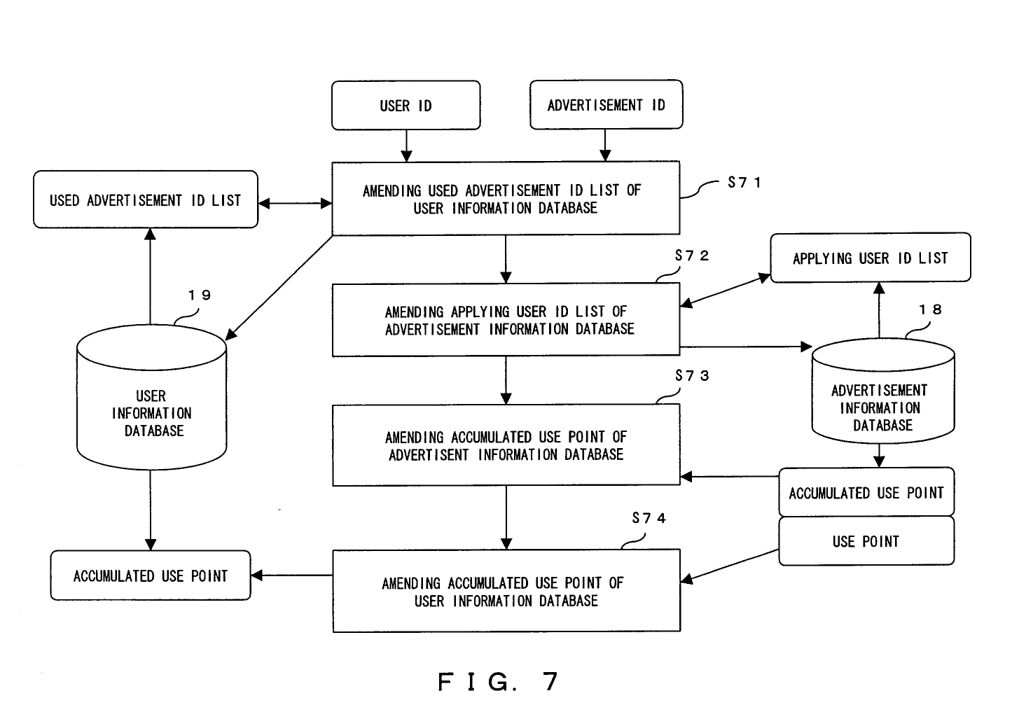

FIG. 7 is a flowchart of the use point process.

First, in step S71, the used advertisement ID list of the user information database 19 is amended using the used advertisement ID list, the user ID, and the advertisement ID.

In step S72, the applying user ID list of the advertisement information database 18 is amended, and the accumulated use point of the advertisement information database 18 is amended in step S73.

In step S74, the accumulated use point of the user information database 19 is amended.

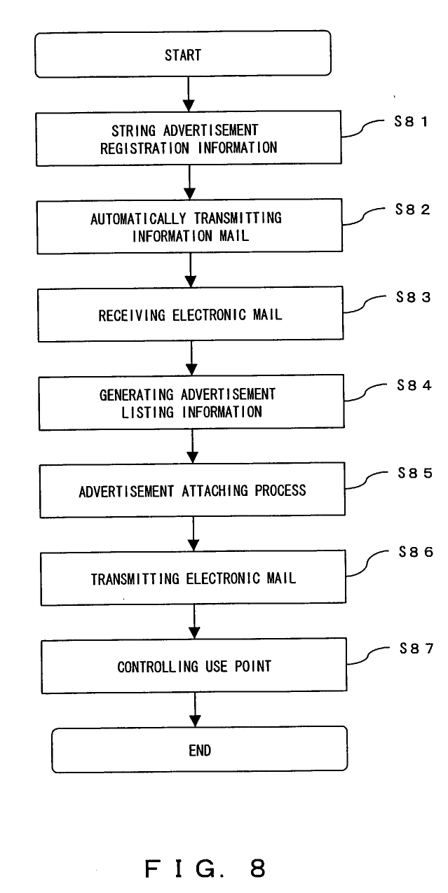

FIG. 8 is a flowchart of the relay control process of the electronic mail.

In step S81, the advertisement registration information 31 from the client device (commercial sponsor terminal) 3A is stored in the advertisement information database 18 in advance.

Then, in step S82, the information mail automatic transmission unit 12 automatically transmits the information mail to the client device (transmitter terminal) 3B.

In step S83, the electronic mail reception unit 13 receives the electronic mail (electronic mail 33 to which an advertisement is to be attached) addressed to the client device (receiver terminal) 3C from the client device (transmitter terminal) 3B.

In step S84, the advertisement list information generation unit 14 generates advertisement list information, and the advertisement attachment unit 15 attaches the advertisement information in step S85 to the electronic mail received in step S83.

In step S86, the electronic mail with the advertisement information attached in step S85 is transmitted to the client device (receiver terminal) 3C.

Finally, in step S87, the use point control unit 17 performs the use point process described by referring to FIG. 7.

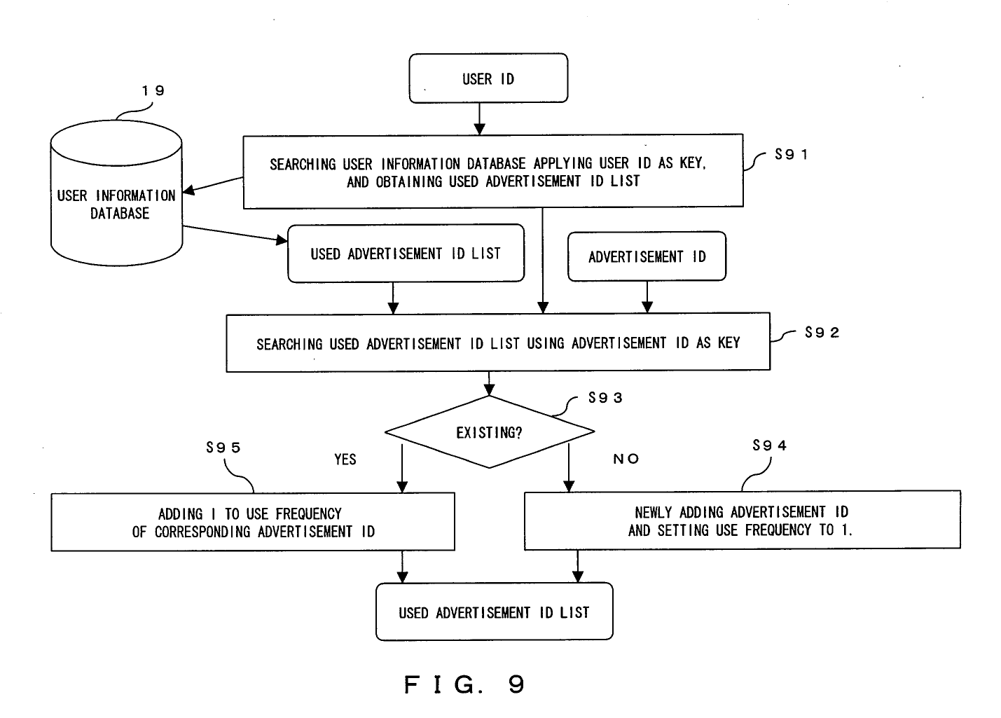

Then, the practical process of the use point process is described below by referring to FIGS. 9 through 12.

In the use point process, the used advertisement ID list of the user information database 19 is first amended. Then, the accumulated use point of the advertisement information database 18 is amended. Finally, the accumulated use point of the user information database 19 is amended.

FIG. 9 is a flowchart of the process of amending the used advertisement ID list of the user information database.

In step S91, the user information database 19 is searched using the user ID as a key, and a used advertisement ID list is obtained.

Then, in step S92, the used advertisement ID list obtained in step S91 is searched using the advertisement ID as a key.

In step S93, it is determined whether or not an advertisement ID exists.

If it is determined in step S93 that no advertisement ID exists (NO in step S93), then an advertisement ID is newly added in step S94, and the use frequency is set to 1.

On the other hand, if it is determined in step S93 that an advertisement ID exists (YES in step S93), then the use frequency of the corresponding advertisement ID is incremented by 1 in step S95.

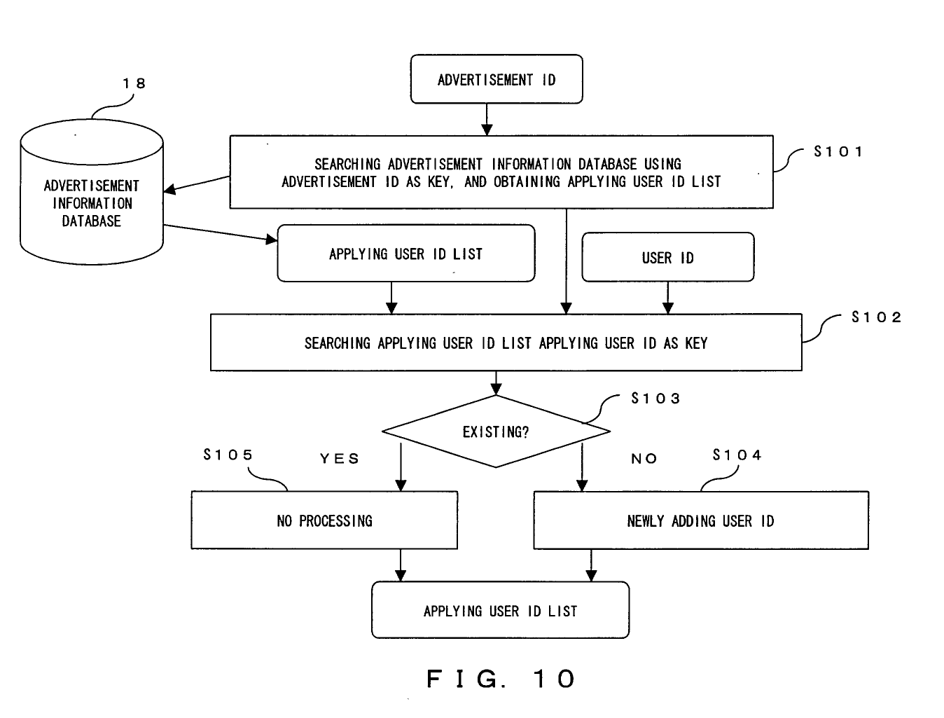

FIG. 10 is a flowchart of the process of amending the applying user ID lift of the advertisement information database.

In step S101, the advertisement information database 18 is searched using the advertisement ID as a key, and an applying user ID list is obtained.

Then, in step S102, the applying user ID list obtained in step S101 is searched using the user ID as a key.

In step S103, it is determined whether or not a user ID exists.

If it is determined in step S103 that no user ID exists (NO in step S103), then a user ID is newly added in step S104.

On the other hand, if it is determined in step S103 that a user ID exists (YES in step S103), then the no process is performed on the applying user ID list in step S95.

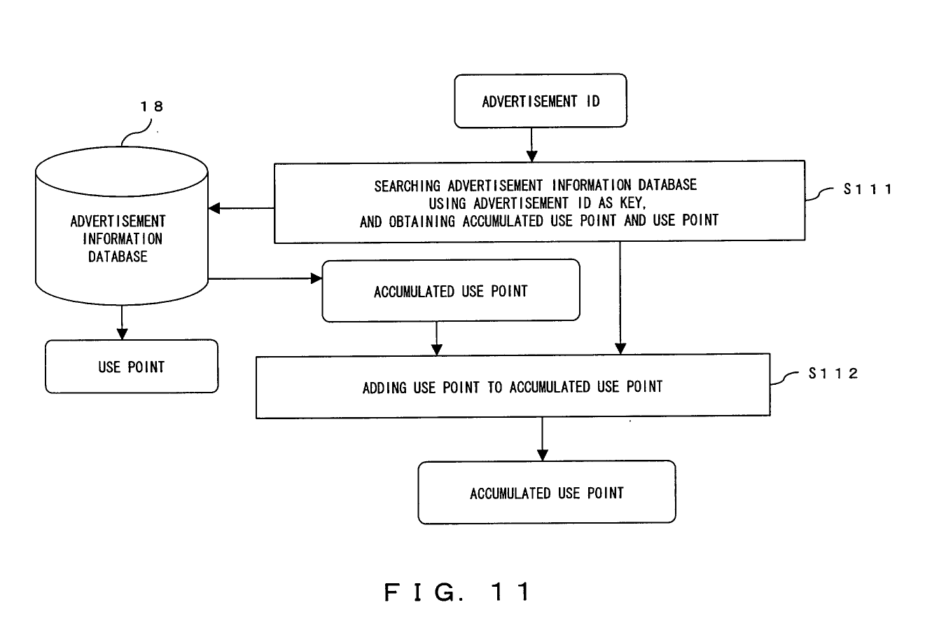

FIG. 11 is a flowchart of the process of amending the accumulated use point of the advertisement information database.

In step S111, the advertisement information database 18 is searched using the advertisement ID as a key, and an accumulated use point and a use point are obtained.

In step S112, the use point obtained in step S111 is added to the accumulated use point obtained in step S111, and the point is updated as a new accumulated use point.

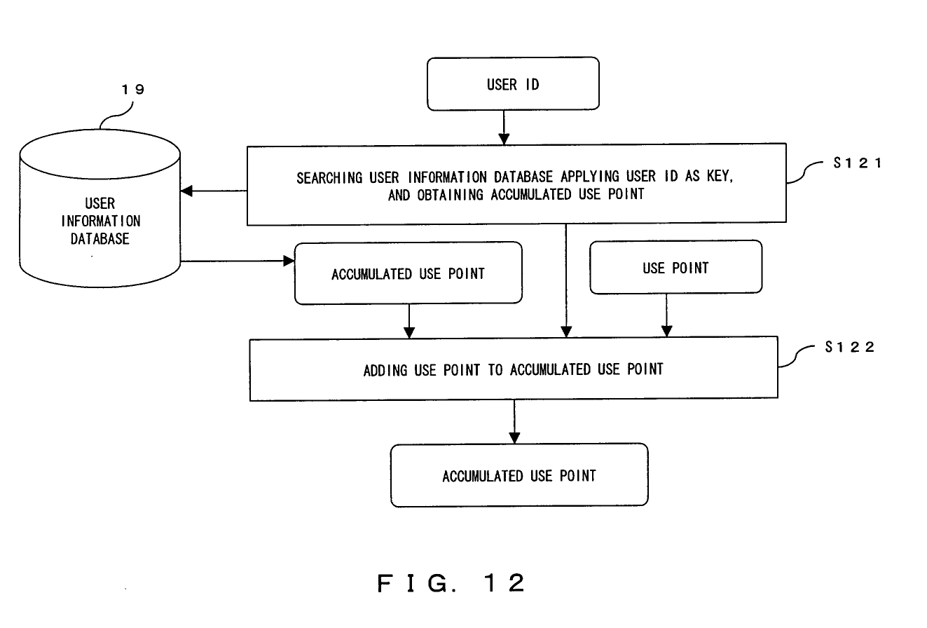

FIG. 12 is a flowchart of the process of amending the accumulated use point of the user information database.

In step S121, the user information database 19 is searched using the user ID as a key, and an accumulated use point is obtained.

Then, in step S122, the use point is added to the accumulated use point obtained in step S121, and the point is updated as a new accumulated use point.

Described below is the process of attaching advertisement information to electronic mail.

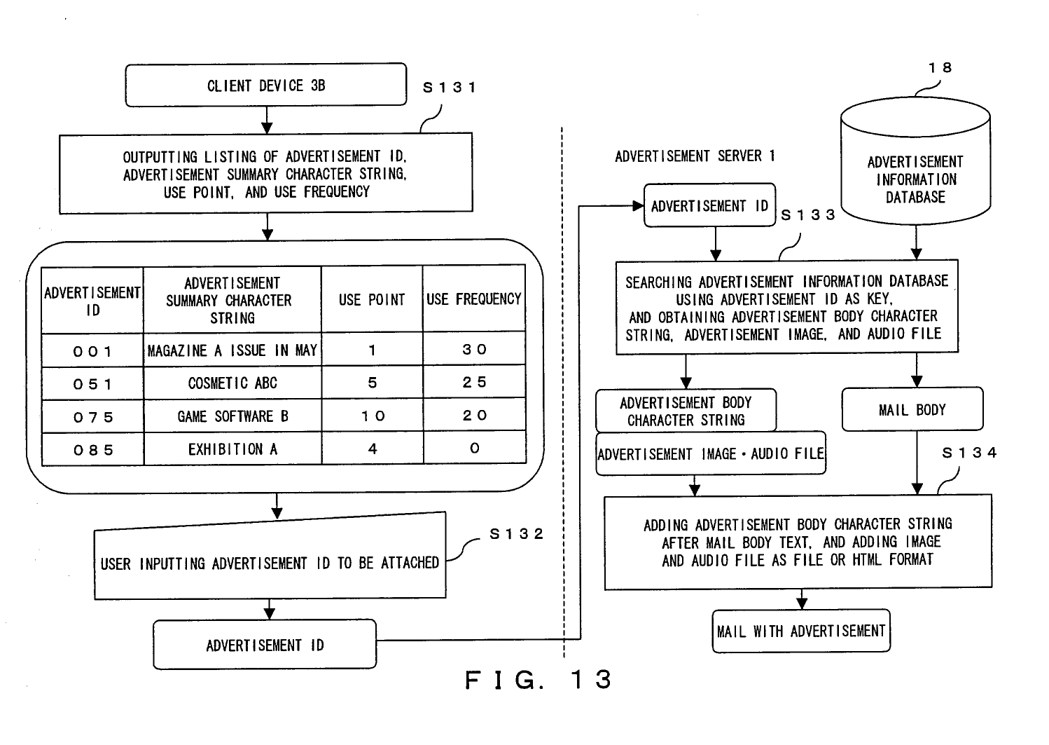

FIG. 13 is a flowchart of the process of attaching advertisement information to electronic mail.

As described above by referring to FIG. 1, the attaching process performed by the advertisement attachment unit 15 is the process of attaching the advertisement information selected by the transmitter terminal (client device 3) from the list (advertisement ID list for display of listing) generated by the advertisement list information generation unit 14 to the electronic mail transmitting to the receiver terminal (client device 3).

First, in step S131, an advertisement ID list for display of advertisement containing an advertisement ID, an advertisement summary character string, a use point, and an advertising frequency is output.

When the user sees the output advertisement ID list for display of advertisement, the user selects and inputs the advertisement ID to be attached.

In step S133, the advertisement information database 18 is searched using the advertisement ID input in step S132 as a key, and an advertisement body character string, an advertisement image, and au audio file are obtained.

In step S134, after the body text of the electronic mail to which the advertisement information is attached, an advertisement character string is added. When there are an advertisement image and an audio file, the advertisement image and the audio file are added in the file format or the HTML format as advertisement-attached electronic mail.

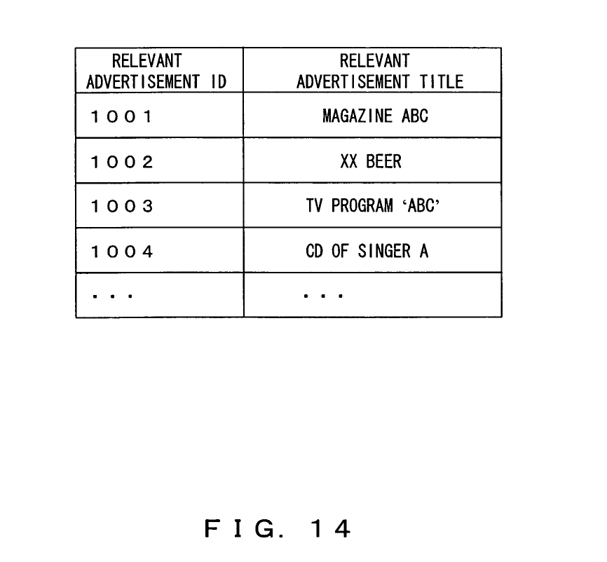

FIG. 14 shows an example of a relevant advertisement ID.

As described above, a relevant advertisement ID refers to an identifier to designate the group of advertisement information (advertisement information class) relating to the advertisement information. In the example shown in FIG. 14, for example, the relevant advertisement ID ‘1001’ indicates an advertisement relating to the ‘magazine ABC’, and the relevant advertisement ID ‘1002’ indicates an advertisement relating to the ‘xx Beer’.

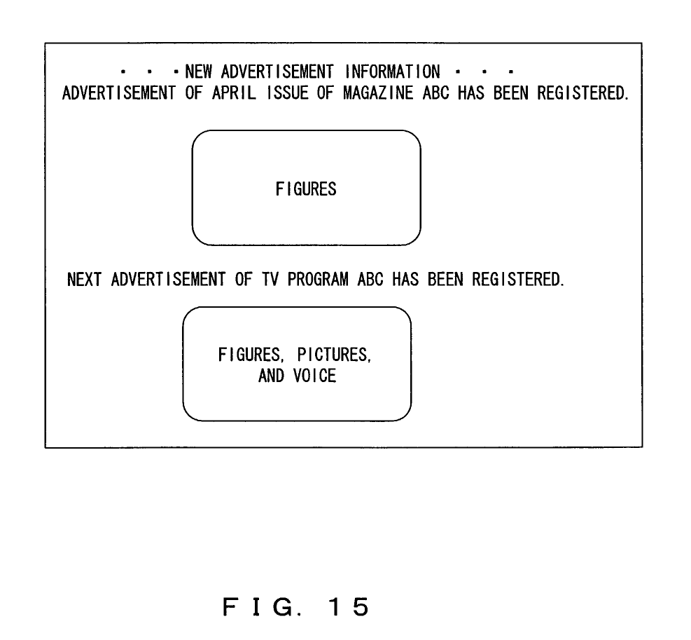

FIG. 15 shows an example of information mail.

As described above by referring to FIG. 1, information mail is electronic mail generated by the information mail automatic transmission unit 12 according to the advertisement information registered by the advertisement registration information storage unit 11 in the advertisement information database 18 and the user information database 19 storing the information about the user relating to the advertisement information registered in the advertisement information database 18, and is transmitted to the transmitter terminal (client device 3) through the network 2. The example shown in FIG. 15 shows two pieces of newly registered advertisement information. That is, it is informed by referring to the attached drawings that the advertisement of the April issue of the magazine ABC has been registered, and the next advertisement of the TV program ABC is informed using the drawings, pictures, and voice.

As described above, the embodiment of the present invention has been described by referring to the attached drawings, but the advertisement server to which the present invention is applied is not limited to the above mentioned embodiment so far as its function can be carried out, can be a single device or a system or an integrated device comprising a plurality of devices, and can be a system for performing a process through a network such as a LAN, a WAN, etc.

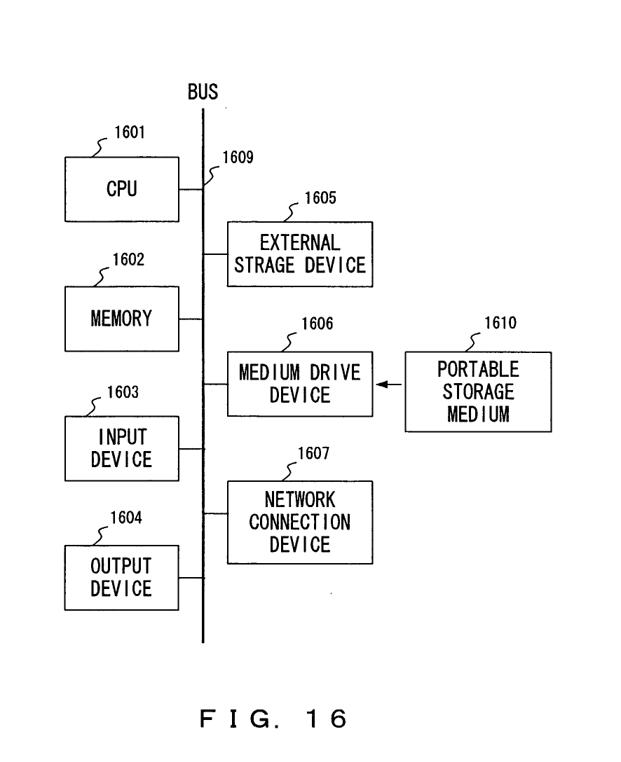

As shown in FIG. 16, the apparatus can also be realized by a system comprising a CPU 1601, memory 1602 such as ROM, RAM, etc., an input device 1603, an output device 1604, an external storage device 1605, a medium drive device 1606, a portable storage medium 1610, and a network connection device 1607 connected via a bus 1609. That is, the memory 1602 such as the ROM and the RAM storing a program code of the software for realizing the system according to the above mentioned embodiment, the external storage device 1605, and the portable storage medium 1610 are provided for the advertisement server, and the computer of the advertisement server reads the program code, thereby realizing the present invention.

In this case, the program code read from the portable storage medium 1610, etc. realizes new functions of the present invention, and the portable storage medium 1610, etc. storing the program code configure the present invention.

The portable storage medium 1610 for providing a program code can be, for example, a flexible disk, a hard disk, an optical disk, a magneto-optic disk, CD-ROM, CD-R, DVD-ROM, DVD-RAM, a magnetic tape, a non-volatile memory card, a ROM card, various storage media using the network connection device 1607 (that is, a communications circuit) for electronic mail, communications through a personal computer, etc.

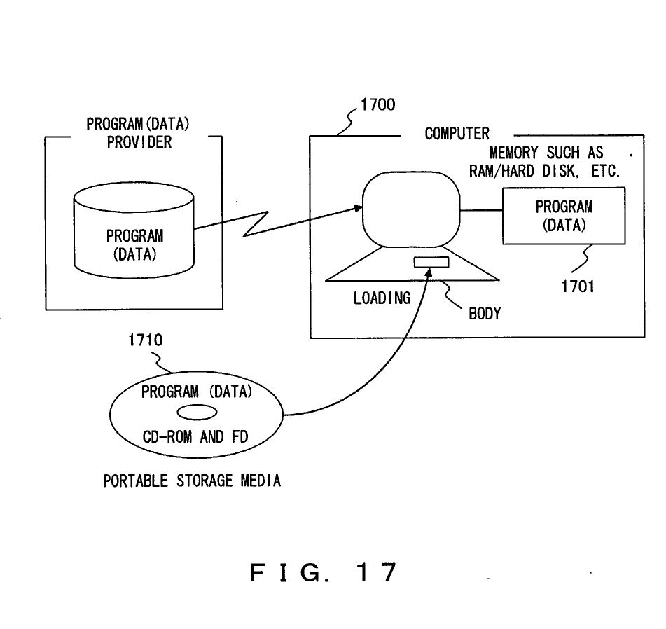

As shown in FIG. 17, the functions according to the above mentioned embodiment can be realized by executing the program code read by a computer 1700 to memory 1701, and at an instruction of the program code, the OS, etc. operating in the computer 1700 perform a part or all of the actual process, thereby realizing the functions according to the above mentioned embodiment.

Furthermore, a program code read from a portable storage medium 1710 and a program (data) provided by a program (data) provider are written to a function extending unit inserted into the computer 1700 and the memory 1701 in a function extending unit connected to the computer 1700, and then, at an instruction of the program code, the CPU, etc. provided in the function extending board and the function extending unit perform a part or all of the actual processes, and the processes can realize the functions of the above mentioned embodiment.

That is, the present invention is not limited to the above mentioned embodiment, but can be realized in various configurations and forms within the scope of the gist of the present invention.

As described above, according to the present invention, each commercial sponsor can freely add an advertisement, and therefore maintains the novelty of the advertisement. Additionally, not only companies, but also personal users can easily be commercial sponsors.

Furthermore, according to the present invention, the information about newly registered advertisement information can be effectively issued.

In addition, according to the present invention, by having a use point depending on each advertisement and displaying it for reference, the issuer of the electronic mail can use the use point as a condition of selecting an advertisement, thereby selecting an advertisement for profit.

Furthermore, according to the present invention, a commercial sponsor can discriminate a specific advertisement from others by setting a higher use point for it, and can manage the use frequencies of advertisements so that the points can be exchanged between the commercial sponsor and a mail issuer. Additionally, a provider can be a complete broker.

In addition, according to the present invention, advertisements can be displayed in order from the highest use frequency when an advertisement list is displayed, thereby allowing an issuer of electronic mail to easily select frequently applied advertisements.

What is claimed is:

1. An advertisement server which attaches advertisement information to electronic mail transmitted from a transmitter terminal to a receiver terminal, and performs relay control therefor, comprising:
an advertisement information database storing advertisement information and advertisement registration information containing an advertisement information identifier to designate the advertisement information and a relevant advertisement information identifier to designate an advertisement information class relating to the advertisement information;
a user information database storing user information containing a transmitter terminal identifier to designate the transmitter terminal and an advertisement information identifier to designate the advertisement information attached to the electronic mail transmitted from the transmitter terminal;
an advertisement list information generation unit generating a list of the advertisement information relating to the advertisement information attached to the electronic mail transmitted by the transmitter terminal based on the advertisement information database and the user information database; and
an advertisement attachment unit attaching the advertisement information selected by the transmitter terminal from the list generated by the advertisement list information generation unit to the electronic mail transmitting to the receiver terminal.

2. An advertisement attaching method executed in an advertisement server which attaches advertisement information to electronic mail transmitted from a transmitter terminal to a receiver terminal, and performs relay control therefor, comprising:
generating a list of the advertisement information attached to the electronic mail transmitted by the transmitter terminal based on an advertisement information database and a user information database, and said advertisement information database storing advertisement information and advertisement registration information containing an advertisement information identifier to designate the advertisement information and a relevant advertisement information identifier to designate an advertisement information class relating to the advertisement information, and said user information database storing user information containing a transmitter terminal identifier to designate the transmitter terminal and an advertisement information identifier to designate the advertisement information attached to the electronic mail transmitted from the transmitter terminal; and
attaching the advertisement information selected from the generated list by the transmitter terminal to the electronic mail transmitting to the receiver terminal.

3. The method according to claim 2, wherein
said user information database stores the user information further containing a receiver terminal identifier to designate the receiver terminal; and
said generation of the advertisement list information generates a list of advertisement information relating to the advertisement information attached to the electronic mail transmitted from the transmitter terminal to the receiver terminal.

4. The method according to claim 2, further comprising
receiving the advertisement information and registering the received advertisement information in the advertisement information database together with an advertisement information identifier to designate the received advertisement information and a relevant advertisement information identifier to designate the advertisement information class relating to the received advertisement information.

5. The method according to claim 3, further comprising
receiving the advertisement information and registering the received advertisement information in the advertisement information database together with an advertisement information identifier to designate the received advertisement information and a relevant advertisement information identifier to designate the advertisement information class relating to the received advertisement information.

6. The method according to claim 4, further comprising
generating information mail based on the advertisement information registered in the advertisement information database by registration of the advertisement information and the user information database, and transmitting the mail to the transmitter terminal.

7. The method according to claim 5, further comprising
generating information mail based on the advertisement information registered in the advertisement information database by registration of the advertisement information and the user information database, and transmitting the mail to the transmitter terminal.

8. The method according to claim 6, wherein
said attachment of the information mail transmits the information mail to the transmitter terminal when the advertisement information is registered in the advertisement information database.

9. The method according to claim 7, wherein
said attachment of the information mail transmits the information mail to the transmitter terminal when the advertisement information is registered in the advertisement information database.

10. The method according to claim 2, wherein
said generation of the list of the advertisement information generates a list of advertisement information based on a transmission frequency of advertisement information transmitted as attached to electronic mail.

11. The method according to claim 3, wherein
said generation of the list of the advertisement information generates a list of advertisement information based on a transmission frequency of advertisement information transmitted as attached to electronic mail.

12. The method according to claim 4, wherein
said generation of the list of the advertisement information generates a list of advertisement information based on a transmission frequency of advertisement information transmitted as attached to electronic mail.

13. The method according to claim 5, wherein
said generation of the list of the advertisement information generates a list of advertisement information based on a transmission frequency of advertisement information transmitted as attached to electronic mail.

14. The method according to claim 6, wherein
said generation of the list of the advertisement information generates a list of advertisement information based on a transmission frequency of advertisement information transmitted as attached to electronic mail.

15. The method according to claim 7, wherein
said generation of the list of the advertisement information generates a list of advertisement information based on a transmission frequency of advertisement information transmitted as attached to electronic mail.

16. The method according to claim 2, further comprising
transmitting the list generated by generating a list of the advertisement information to the transmitter terminal.

17. The method according to claim 2, further comprising:
transferring the electronic mail to which the advertisement information is attached by attaching the advertisement information from the transmitter terminal to the receiver terminal; and
adding a use point each time the advertisement information is attached by attaching the advertisement information, and storing the use point in the user information database.

18. The method according to claim 17, wherein
said use point depends on advertisement information.

19. An advertisement information attaching program executed in an advertisement server which attaches advertisement information to electronic mail transmitted from a transmitter terminal to a receiver terminal, and performs relay control therefor, comprising the functions of:
generating a list of the advertisement information attached to the electronic mail transmitted by the transmitter terminal based on an advertisement information database and a user information database, and said advertisement information database storing advertisement information and advertisement registration information containing an advertisement information identifier to designate the advertisement information and a relevant advertisement information identifier to designate an advertisement information class relating to the advertisement information, and said user information database storing user information containing a transmitter terminal identifier to designate the transmitter terminal and an advertisement information identifier to designate the advertisement information attached to the electronic mail transmitted from the transmitter terminal; and
attaching the advertisement information selected from the generated list by the transmitter terminal to the electronic mail transmitting to the receiver terminal.

20. An advertisement server which attaches advertisement information to electronic mail transmitted from a transmitter terminal to a receiver terminal, and performs relay control therefor, comprising:
an advertisement information database storing advertisement information and advertisement registration information containing an advertisement information identifier to designate the advertisement information and a relevant advertisement information identifier to designate an advertisement information class relating to the advertisement information;
a user information database storing user information containing a transmitter terminal identifier to designate the transmitter terminal and an advertisement information identifier to designate the advertisement information attached to the electronic mail transmitted from the transmitter terminal;
advertisement list information generation means for generating a list of the advertisement information relating to the advertisement information attached to the electronic mail transmitted by the transmitter terminal based on the advertisement information database and the user information database; and
advertisement attachment means for attaching the advertisement information selected by the transmitter terminal from the list generated by the advertisement list information generation unit to the electronic mail transmitting to the receiver terminal.
